(19) United States
(12) Patent Application Publication
(10) Pub. No.: US 2025/0271285 A1
(43) Pub. Date: Aug. 28, 2025

(54) SYSTEM AND METHOD FOR MONITORING ANALOG FRONT-END (AFE) CIRCUITRY OF AN INDUCTIVE POSITION SENSOR

(71) Applicant: Microchip Technology Incorporated, Chandler, AZ (US)

(72) Inventors: Naveen Cannankurichi, Hyderabad (IN); Jebas Paul Daniel T., Tirunelveli (IN); Rahul Thottathil, Malappuram (IN); Sunny Joel, Hyderabad (IN)

(73) Assignee: Microchip Technology Incorporated, Chandler, AZ (US)

(21) Appl. No.: 19/064,422

(22) Filed: Feb. 26, 2025

(30) Foreign Application Priority Data
Feb. 26, 2024 (IN) 202441013769

(51) Int. Cl. G01D 5/244; G01B 7/00; G01D 3/08; G01D 5/20

(52) U.S. Cl. CPC G01D 5/24466; G01B 7/003; G01D 3/08; G01D 5/2073; G01D 5/24461

(57) ABSTRACT

A system for monitoring analog-front-end (AFE) circuitry of an inductive position sensor is provided. The system may include a sine signal AFE channel coupled to the inductive position sensor, a sine AFE channel buffer, a cosine signal AFE channel coupled to the inductive position sensor, a cosine AFE channel buffer, an automatic gain control (AGC) circuit coupled to the sine signal AFE channel, a memory to store a plurality of parameters, and a processor. The processor may obtain a first voltage difference between a sine AFE output voltage and an estimated sine AFE output voltage, obtain a second voltage difference between a cosine AFE output voltage and an estimated cosine AFE output voltage, determine if the first or second voltage difference is greater than a predetermined threshold value, and signal a fault condition if the first or second voltage difference is greater than the predetermined threshold value.

### CROSS REFERENCE TO RELATED APPLICATIONS

The present application claims priority to India Provisional Patent Application No. 202441013769, entitled: System and Method for Monitoring Analog Front-End (AFE) Circuitry of an Inductive Position Sensor, filed on Feb. 26, 2024, the contents of which are hereby incorporated by reference in their entirety.

### TECHNICAL FIELD

The present disclosure relates generally to inductive position sensors, and more specifically to a system and method for detecting the angular deviation resulting from inaccuracies present in the analog front-end (AFE) circuitry of the inductive position sensor that resolves the angular position.

### SUMMARY

According to an aspect of one or more examples, there is provided a system to monitor analog-front-end (AFE) circuitry of an inductive position sensor. The system may include a sine signal AFE channel coupled to the inductive position sensor, a sine AFE channel buffer, a cosine signal AFE channel coupled to the inductive position sensor, a cosine AFE channel buffer, an automatic gain control (AGC) circuit, a memory to store a plurality of parameters and a processor. The AGC circuit may be coupled to the sine signal AFE channel and the cosine signal AFE channel to form an AGC loop to control an amplitude of an input analog sine wave and an input analog cosine wave. The processor may obtain a first voltage difference between a sine AFE output voltage and an estimated sine AFE output voltage. The processor may obtain a second voltage difference between a cosine AFE output voltage and an estimated cosine AFE output voltage. The processor may determine if the first or second voltage difference is greater than a predetermined threshold value. The processor may signal a fault condition if the first or second voltage difference is greater than the predetermined threshold value.

The AGC circuit may maintain a sum of squares of the input analog sine wave and the input analog cosine wave to a constant value. The plurality of parameters may include a default radius, an initial error threshold, a conservative error threshold, and a maximum allowable error count within a fault tolerable time interval (FTTI). The first or second voltage difference may be attributable to one or more error sources at the AFE circuitry of the inductive position sensor. The inductive position sensor may be selected from a rotary position sensor and a linear position sensor. The system may include a temperature sensor to measure an internal temperature. The processor may read a default radius from the memory. The processor may acquire the sine AFE output voltage from the sine AFE channel buffer and the cosine AFE output voltage from the cosine AFE channel buffer. The processor may estimate a current radius based on the sine AFE output voltage and the cosine AFE output voltage. The processor may rectify the default radius based on the internal temperature and a temperature slope. The processor may calculate the estimated sine AFE output voltage based on a rectified default radius and the cosine AFE output voltage. The processor may calculate the estimated cosine AFE output voltage based on the rectified default radius and the sine AFE output voltage. The processor may adjust error thresholds based on temperature variations detected by a temperature sensor. The system may include a diagnostic module to perform periodic self-tests of the AFE circuitry. The system may log error events and store fault data in the memory for diagnostic analysis.

According to an aspect of one or more examples, there is provided a method for monitoring analog-front-end (AFE) circuitry of an inductive position sensor. The method may include establishing an automatic gain control (AGC) loop to control an amplitude of an input analog sine wave and an input analog cosine wave using an AGC circuit coupled to a sine signal AFE channel and a cosine signal AFE channel, obtaining a first voltage difference between a sine AFE output voltage and an estimated sine AFE output voltage, obtaining a second voltage difference between a cosine AFE output voltage and an estimated cosine AFE output voltage, determining if the first or second voltage difference is greater than a predetermined threshold value, and signaling a fault condition if the first or second voltage difference is greater than the predetermined threshold value.

The AGC circuit may maintain a sum of squares of the input analog sine wave and the input analog cosine wave to a constant value. The method may include storing a plurality of parameters in a memory. The plurality of parameters may include a default radius, an initial error threshold, a conservative error threshold, and a maximum allowable error count within a fault tolerable time interval (FTTI). The first or second voltage difference may be attributable to one or more error sources at the AFE circuitry of the inductive position sensor. The inductive position sensor may be selected from a rotary position sensor and a linear position sensor. The method may include measuring an internal temperature through a temperature sensor. The method may include reading a default radius from a memory, acquiring the sine AFE output voltage from a sine AFE channel buffer and the cosine AFE output voltage from a cosine AFE channel buffer, estimating a current radius based on the sine AFE output voltage and the cosine AFE output voltage, rectifying the default radius based on an internal temperature and a temperature slope, calculating the estimated sine AFE output voltage based on a rectified default radius and the cosine AFE output voltage, and calculating the estimated cosine AFE output voltage based on the rectified default radius and the sine AFE output voltage. The method may include transmitting fault condition data to an external monitoring system. The method may include adjusting input gain control parameters based on historical performance data stored in the memory.

### BRIEF DESCRIPTION OF DRAWINGS

FIG. 1 shows a block diagram illustrating a system for monitoring AFE circuitry of an inductive position sensor according to one or more examples.

FIG. 2 shows a flowchart illustrating a method for monitoring AFE circuitry of an inductive position sensor according to one or more examples.

FIGS. 3A and 3B show a flowchart illustrating blocks for error detection in an inductive position sensor according to one or more examples.

FIG. 4 shows a plot illustrating a relationship between an angle error and radius variation due to an offset in a sine output signal according to one or more examples.

FIG. 5 shows a plot illustrating a relationship between an angle error and radius variation due to an offset in a cosine output signal according to one or more examples.

FIG. 6 shows a plot illustrating a relationship between an angle error and radius variation due to a gain in a sine output signal according to one or more examples.

FIG. 7 shows a plot illustrating a relationship between an angle error and radius variation due to a gain in a cosine output signal according to one or more examples.

FIG. 8 shows a plot illustrating a relationship between an angle error and radius variation due to a propagation delay in a sine output signal according to one or more examples.

FIG. 9 shows a plot illustrating a relationship between an angle error and radius variation due to a propagation delay in a cosine output signal according to one or more examples.

FIG. 10 shows a plot illustrating a relationship between an angle error and radius variation due to a third harmonic in a sine output signal according to one or more examples.

FIG. 11 shows a plot illustrating a relationship between an angle error and radius variation due to a fifth harmonic in a sine output signal according to one or more examples.

FIG. 12 shows a plot illustrating a relationship between an angle error and radius variation due to a third harmonic in a cosine output signal according to one or more examples.

FIG. 13 shows a plot illustrating a relationship between an angle error and radius variation due to a fifth harmonic in a cosine output signal according to one or more examples.

### DETAILED DESCRIPTION OF VARIOUS EXAMPLES

Reference will now be made in detail to the following various examples, which are illustrated in the accompanying drawings, wherein like reference numerals refer to like elements throughout. The following examples may be embodied in various forms without being limited to the examples set forth herein.

In order to conform to automotive safety integrity level (ASIL) ratings, an inductive position sensor may need to be able to self-diagnose for analog signal processing errors that may result in computational angle errors at the ECU, which may be considered a fault condition. In the case of single point failures, where the entire system may be compromised, it may be advantageous that these errors be detected and communicated to the ECU. Some inductive position sensors detect these errors using redundant channels, thus increasing the overall die area and the cost. Therefore, there is a need for an improved system and method for monitoring the analog front-end (AFE) circuitry of an inductive position sensor to identify errors without any redundant channels. The inductive position sensor may be a rotary sensor or a linear sensor, wherein angular or linear mechanical displacement is converted to electrical signals based upon the angular displacement of the sensor receiver coils.

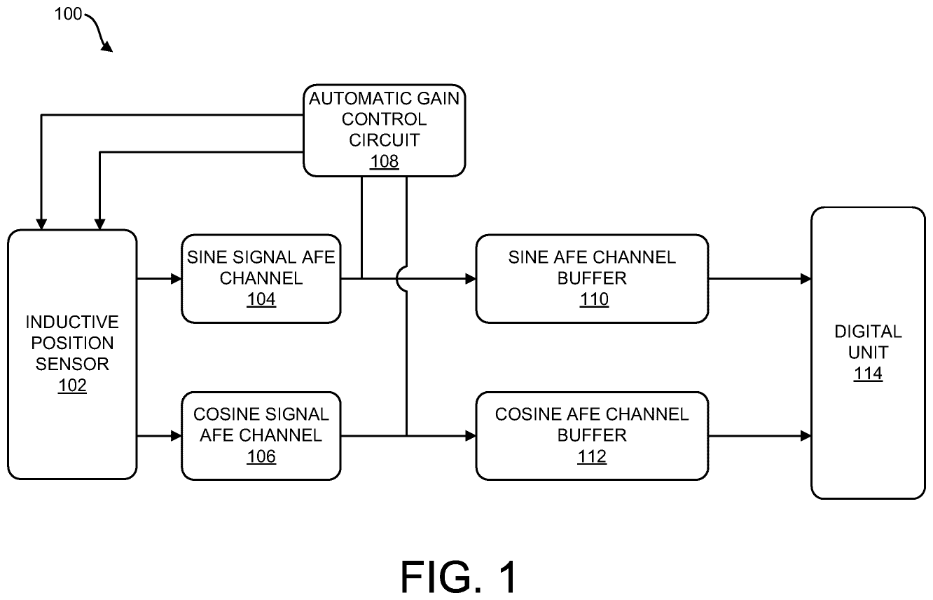

FIG. 1 shows a block diagram illustrating a system 100 for monitoring an analog front-end (AFE) circuitry of an inductive position sensor according to one or more examples. The system 100 may include an inductive position sensor 102, a sine signal AFE channel 104, a cosine signal AFE channel 106, an automatic gain control circuit 108, a sine AFE channel buffer 110, a cosine AFE channel buffer 112, and a digital unit 114. The system 100 may include a temperature sensor (not shown) to measure an internal temperature (Tint).

The inductive position sensor 102 may include a transmitter coil, an oscillator and receiver coils. The oscillator may drive the transmitter coil to generate a time-varying magnetic field. The time-varying magnetic field may induce eddy currents in a conductive target positioned between the transmitter coil and the receiver coils. The receiver coils may respond to changes in a linear or rotational position of the conductive target. The inductive position sensor 102 may produce a raw sensor data. The raw sensor data may include input analog sine waves and input analog cosine waves. The input analog sine waves and the input analog cosine waves may be provided as input to the analog front-end circuitry. The analog front-end (AFE) circuitry may include the sine AFE channel buffer 110 and the cosine AFE channel buffer 112 to demodulate, amplify, and filter the input analog sine waves and the input analog cosine waves respectively. The outputs of the sine AFE channel buffer 110 and the cosine AFE channel buffer 112 may be sent to the digital unit 114. The outputs may be monitored by the digital unit 114 and the angular position of the conductive target may be calculated using the arctangent of the ratio of the input analog sine wave and the input analog cosine wave.

The AFE circuitry may have characteristics such as gain and offset. The characteristics may be calibrated during the fabrication process of the integrated circuit. However, when the inductive position sensor 102 is subsequently placed in the field, previously unidentified defects in the integrated circuit may cause the AFE circuitry to prematurely age, resulting in a slowly drifting offset, gain, or phase delay in the sine signal AFE channel 104 or the cosine signal AFE channel 106. The error resulting from these drifting parameters may introduce errors into the system 100. The input analog sine wave may be processed through the sine signal AFE channel 104 and the input analog cosine wave may be processed through the cosine signal AFE channel 106 that is different from the sine signal AFE channel 104. As such, the different signal channels of the raw sensor data represented by the input analog sine waves and the input analog cosine waves may introduce errors into the data. These errors may include offset errors, gain errors, and phase errors.

An offset error may occur when one or both of the input analog sine wave and the input analog cosine wave are differentially shifted in the voltage domain. Gain errors may occur when there are different gains in the sine signal AFE channel 104 and the cosine signal AFE channel 106 that result in different amplitudes. Phase errors in the data may result when the phase shift resulting from the sine signal AFE channel 104 and the cosine signal AFE channel 106 are not equal to 90°. In general, both DC (static) and AC (dynamic) errors may be introduced by the AFE circuitry into the sine signal AFE channel 104 and the cosine signal AFE channel 106.

The sine signal AFE channel 104 may be coupled to the inductive position sensor 102 to process the input analog sine wave generated by the inductive position sensor 102. Similarly, the cosine signal AFE channel 106 may be coupled to the inductive position sensor 102 to process the input analog cosine wave generated by the inductive position sensor 102. The automatic gain control circuit 108 may be coupled to the sine signal AFE channel 104 and the cosine signal AFE channel to form an AGC loop to control an amplitude of the input analog sine wave and the input analog cosine wave. The AGC circuit 108 may maintain a sum of squares of the input analog sine wave and the input analog cosine wave to a constant value. The AGC loop may be a feedback loop that adjusts the gain errors of the input analog sine waves and the input analog cosine waves. The AGC loop may include a first oscillator and a second oscillator. The first oscillator and the second oscillator may generate one or more stable and precise reference signals. The AGC circuit 108 may compare the input analog sine wave and the input analog cosine wave with the stable and precise reference signals generated by the first oscillator and the second oscillator. The AGC circuit 108 may ensure that the input analog sine waves and the input analog cosine waves remain within a range for subsequent processing.

The sine AFE channel buffer 110 may include a first electromagnetic interference filter, a first demodulator, a first programmable gain amplifier, and a first analog-to-digital converter. The first electromagnetic interference filter may attenuate high-frequency noise from the input analog sine wave. The first demodulator may extract low-frequency relevant information from the input analog sine wave. The first programmable gain amplifier may adjust the gain dynamically for the input analog sine wave to allow precise control over the amplification factor. The first analog-to-digital converter may convert the input analog sine waves to discrete sine digital values which correspond to a sine AFE output voltage (ADC₁).

The cosine AFE channel buffer 112 may include a second electromagnetic interference filter, a second demodulator, a second programmable gain amplifier, and a second analog-to-digital converter. The second electromagnetic interference filter may attenuate high-frequency noise from the input analog cosine wave. The second demodulator may extract low-frequency relevant information from the input analog cosine wave. The second programmable gain amplifier may adjust the gain dynamically for the input analog cosine wave to allow precise control over the amplification factor. The second analog-to-digital converter may convert the input analog cosine waves to discrete cosine digital values which correspond to a cosine AFE output voltage (ADC₂).

The digital unit 114 may include a memory and a processor. The memory may correspond to a computer readable storage medium. The memory may include one or more of volatile and non-volatile memories, such as Random-Access Memory (“RAM”), Read-Only Memory (“ROM”), Erasable Programmable Read-Only Memory (“EPROM”), Electrically Erasable Programmable Read-Only Memory (“EEPROM”), a solid-state disk (“SSD”), Flash, Phase Change Memory (“PCM”), or other types of data storage. The memory may store instructions which, when executed, cause the system 100 to perform a method according to various examples described herein. The memory may store a plurality of parameters. The plurality of parameters may include a default radius (default_rad), an initial error threshold (error_init_tol), a conservative error threshold (error_tol), and a maximum allowable error count (error_count_max) within a fault tolerable time interval (FTTI).

The processor may read the default radius from the memory. The processor may acquire the sine AFE output voltage (ADC₁) from the sine AFE channel buffer 110 and the cosine AFE output voltage (ADC₂) from the cosine AFE channel buffer 112. The processor may estimate a current radius (current_rad) based on the sine AFE output voltage (ADC₁) and the cosine AFE output voltage (ADC₂). The current radius may be expressed as a square root of the sum of squares of the sine AFE output voltage and the cosine AFE output voltage (current_rad=√(ADC₁²+ADC₂²)). The processor may receive the internal temperature from the temperature sensor. The processor may rectify the default radius based on the internal temperature and a temperature slope (rad_t). A rectified default radius (default_rad_corrected) may be expressed as:

$$default\_rad \_corrected = default\_rad + rad\_t \times ( {T}_{int} / 25 ° Celsius )$$

The processor may calculate an estimated sine AFE output voltage (ADC₁_est) based on the rectified default radius and the cosine AFE output voltage. The estimated sine AFE output voltage may be expressed as a square root of the sum of squares of the rectified default radius and the cosine AFE output voltage (ADC₁_est=√(default_rad_corrected²+ADC₂²)). The processor may calculate an estimated cosine AFE output voltage (ADC₂_est) based on the rectified default radius and the sine AFE output voltage. The estimated cosine AFE output voltage may be expressed as a square root of the sum of squares of the rectified default radius and the sine AFE output voltage (ADC₂_est=√(default_rad_corrected²+ADC₁²)).

The processor may obtain a first voltage difference between the sine AFE output voltage and the estimated sine AFE output voltage. The processor may obtain a second voltage difference between the cosine AFE output voltage and the estimated cosine AFE output voltage. The first or second voltage difference is attributable to one or more error sources at the AFE circuitry of the inductive position sensor 102. The one or more error sources may be any of offset errors, common mode errors, gain errors, errors resulting from a delay between the sine and cosine signal AFE channels and errors resulting from generated harmonics. The processor may determine if the first or second voltage difference is greater than a predetermined threshold value. The predetermined threshold value may be the initial error threshold or the conservative error threshold. The processor may signal a fault condition if the first or second voltage difference is greater than the predetermined threshold value.

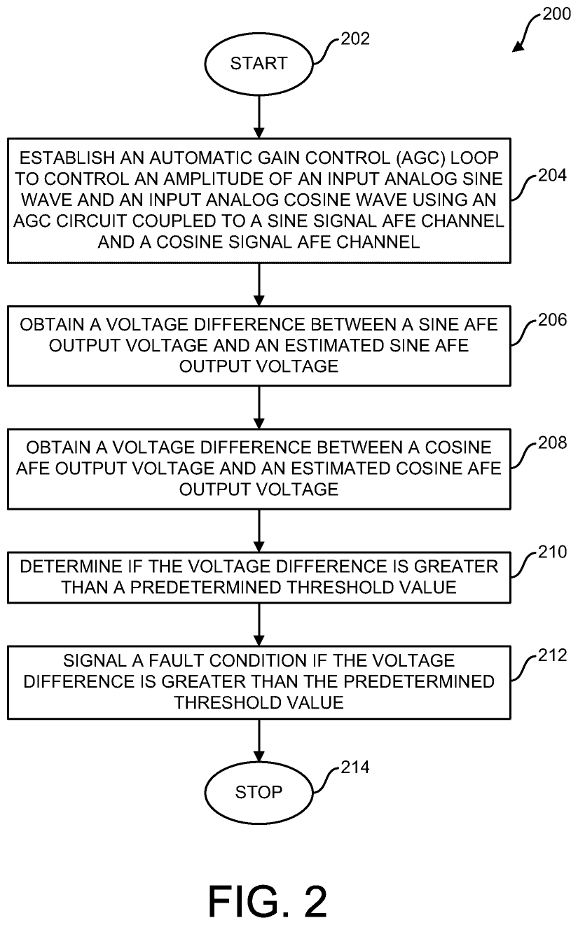

FIG. 2 shows a flowchart 200 illustrating a method for monitoring the AFE circuitry of the inductive position sensor according to one or more examples. It may be noted that in order to explain the blocks of the flowchart 200, references will be made to the elements explained in FIG. 1.

The flowchart 200 starts at block 202. At block 204, the method may include establishing the AGC loop to control the amplitude of the input analog sine wave and the input analog cosine wave using the AGC circuit 108 coupled to the sine signal AFE channel 104 and the cosine signal AFE channel 106. At block 206, the method may include obtaining the first voltage difference between the sine AFE output voltage and the estimated sine AFE output voltage. At block 208, the method may include obtaining the second voltage difference between the cosine AFE output voltage and the estimated cosine AFE output voltage. At block 210, the method may include determining if the first or second voltage difference is greater than the predetermined threshold value. At block 212, the method may include signaling the fault condition if the first or second voltage difference is greater than the predetermined threshold value.

The flowchart 200 terminates at block 214. It may be noted that the flowchart 200 is explained to have above stated process blocks; however, those skilled in the art would appreciate that the flowchart 200 may have more/less number of process blocks which may enable all the above stated examples of the present disclosure.

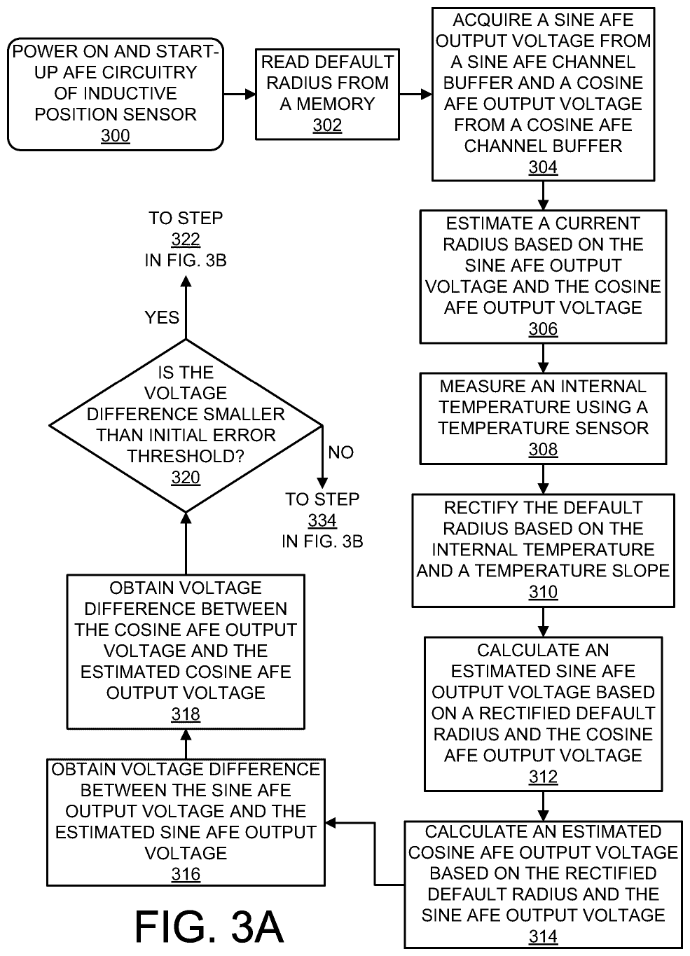

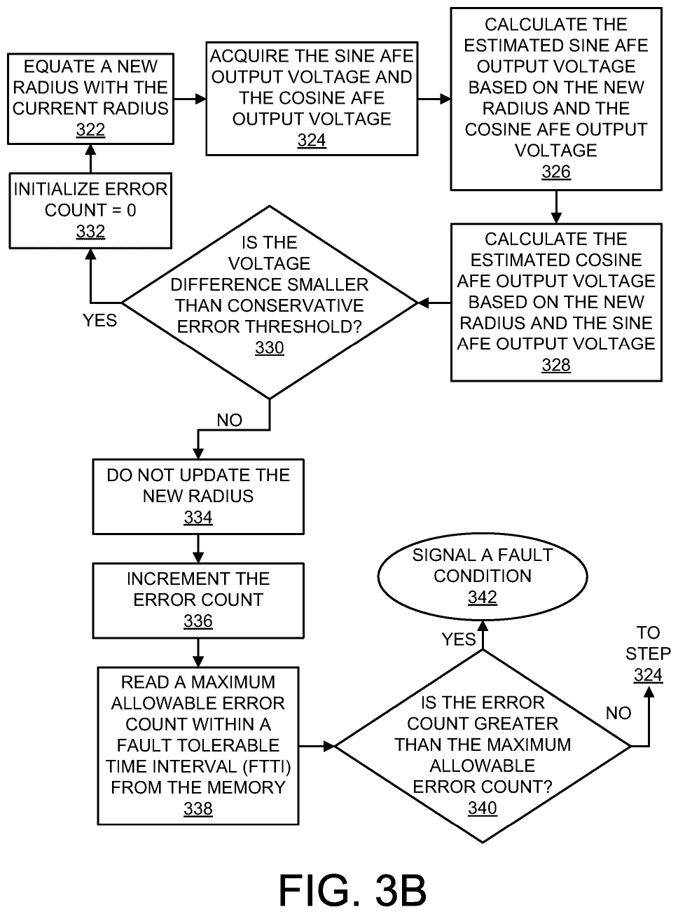

FIGS. 3A and 3B in combination, illustrate a flow diagram according to various examples for monitoring the AFE circuitry of the inductive position sensor. At operation 300, power on and start-up of the AFE circuitry of the inductive position sensor may be performed. At operation 302, the default radius from the memory may be read. At operation 304, the sine AFE output voltage from the sine AFE channel buffer 110 and the cosine AFE output voltage from the cosine AFE channel buffer 112 may be acquired. At operation 306, the current radius may be estimated based on the sine AFE output voltage and the cosine AFE output voltage. At operation 308, the internal temperature may be measured using the temperature sensor. At operation 310, the default radius may be rectified based on the internal temperature and the temperature slope. At operation 312, the estimated sine AFE output voltage may be calculated based on the rectified default radius and the cosine AFE output voltage. At operation 314, the estimated cosine AFE output voltage may be calculated based on the rectified default radius and the sine AFE output voltage.

At operation 316, the first voltage difference between the sine AFE output voltage and the estimated sine AFE output voltage may be obtained. At operation 318, the second voltage difference between the cosine AFE output voltage and the estimated cosine AFE output voltage may be obtained. At operation 320, it is determined whether or not the first or second voltage difference is smaller than the initial error threshold. If the first or second voltage difference is smaller than the initial error threshold, at operation 322, the new radius may be equated with the current radius. At operation 324, the sine AFE output voltage and the cosine AFE output voltage may be acquired. At operation 326, the estimated sine AFE output voltage may be calculated based on the new radius and the cosine AFE output voltage. At operation 328, the estimated cosine AFE output voltage may be calculated based on the new radius and the sine AFE output voltage. At operation 330, it is determined whether or not the first or second voltage difference is smaller than the conservative error threshold. If the first or second voltage difference is smaller than the conservative error threshold, at operation 332, the error count may be initialized (error count=0) and operation 322 may be performed again.

At operation 334, the new radius may not be updated if the first or second voltage difference is greater than the initial error threshold (operation 320) or the first or second voltage difference is greater than the conservative error threshold (operation 330). At operation 336, the error count may be incremented (error count=error count+1). At operation 338, the maximum allowable error count within the fault tolerable time interval (FTTI) may be read from the memory. At operation 340, it is determined whether or not the error count is greater than the maximum allowable error count. If the error count is greater than the maximum allowable error count, at operation 342, the fault condition may be signaled. If it is determined that the error count is not greater than the maximum allowable error count in operation 340, operation 324 may be performed again.

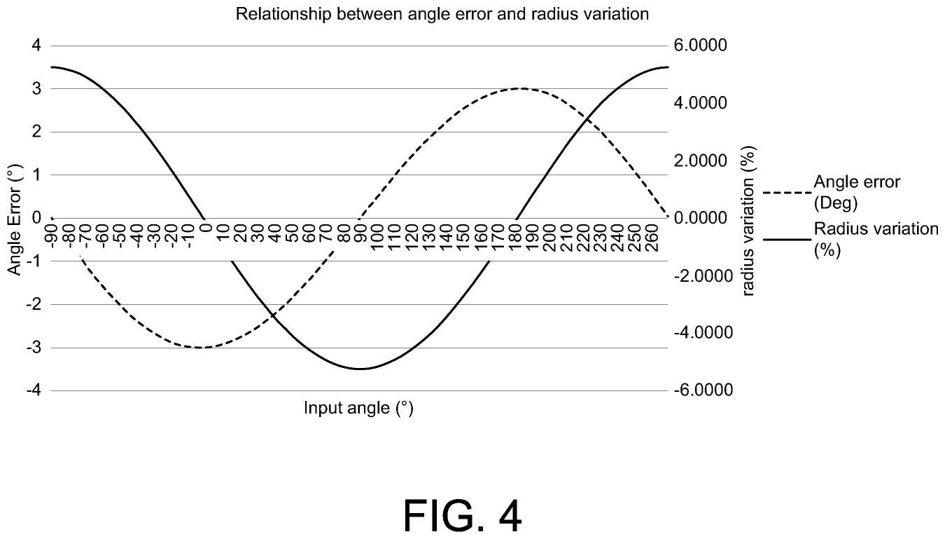

FIG. 4 shows a plot illustrating a relationship between an angle error and radius variation due to an offset in a sine output signal according to one or more examples. The plot may represent impact of the offset on the sine output signal and changes in the angle error and the radius variation for an input angle. The sine output signal may be obtained from the system 100. The input angle may range from −90 degrees to 270 degrees. The angle error is represented by a dark gray curve. The angle error may range from −3 degrees to 3 degrees. The angle error is about 0 degrees when the input angle is −90 degrees. As the input angle may move to 0 degrees, the angle error is about −3 degrees. As the input angle may move to 90 degrees, the angle error is about 0 degrees. As the input angle may move to 180 degrees, the angle error is about 3 degrees. As the input angle may move to 270 degrees, the angle error is about 0 degrees. The radius variation is represented by a light gray curve. The radius variation may range from about −5.25 percent to about 5.25 percent. The radius variation is about 5.25 percent when the input angle is −90 degrees. As the input angle may move to 0 degrees, the radius variation is about 0 percent. As the input angle may move to 90 degrees, the radius variation is about −5.25 percent. As the input angle may move to 180 degrees, the radius variation is about 0 percent. As the input angle may move to 270 degrees, the radius variation is about 5.25 percent.

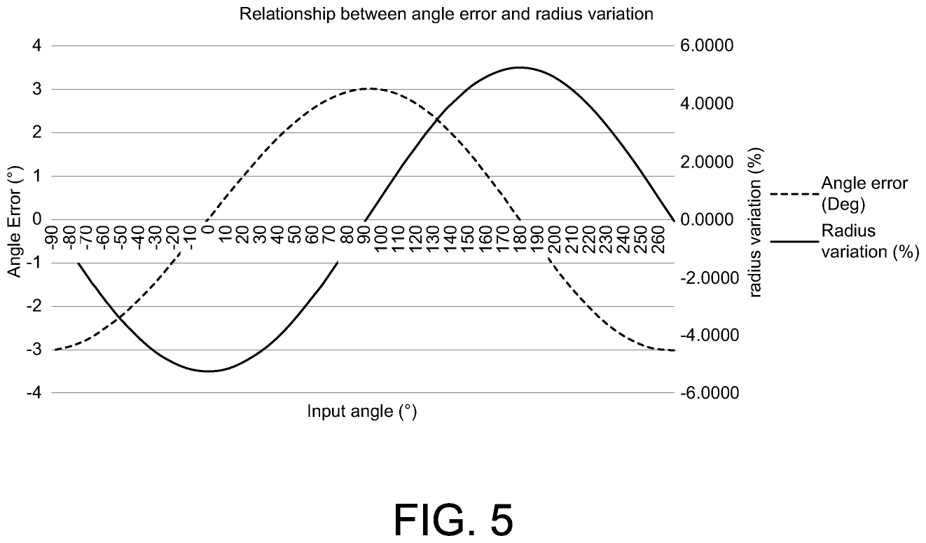

FIG. 5 shows a plot illustrating a relationship between an angle error and radius variation due to an offset in a cosine output signal according to one or more examples. The plot may represent impact of the offset in the cosine output signal and changes in the angle error and the radius variation for the input angle. The cosine output signal may be obtained from the system 100. The angle error is represented by a dark gray curve. The angle error may range from about −3 degrees to about 3 degrees. The angle error is about −3 degrees when the input angle is −90 degrees. As the input angle may move to 0 degrees, the angle error is about 0 degrees. As the input angle may move to 90 degrees, the angle error is about 3 degrees. As the input angle may move to 180 degrees, the angle error is about 0 degrees. As the input angle may move to 270 degrees, the angle error is about −3 degrees. The radius variation is represented by a light gray curve. The radius variation may range from about −5.25 percent to about 5.25 percent. The radius variation is about 0 percent when the input angle is −90 degrees. As the input angle may move to 0 degrees, the radius variation is about −5.25 percent. As the input angle may move to 90 degrees, the radius variation is about 0 percent. As the input angle may move to 180 degrees, the radius variation is about 5.25 percent. As the input angle may move to 270 degrees, the radius variation is about 0 percent.

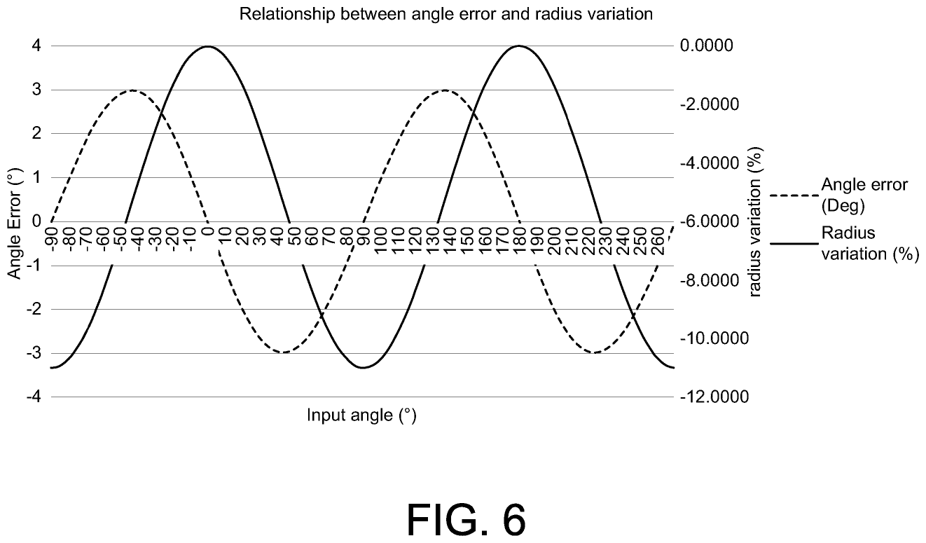

FIG. 6 shows a plot illustrating a relationship between an angle error and radius variation due to a gain in a sine output signal according to one or more examples. The plot may represent impact of the gain in the sine output signal and changes in the angle error and the radius variation for the input angle. The sine output signal may be obtained from the system 100. The angle error is represented by a dark gray curve. The angle error may range from about −3 degrees to about 3 degrees. The radius variation is represented by a light gray curve. The radius variation may range from about −11 percent to about 0 percent.

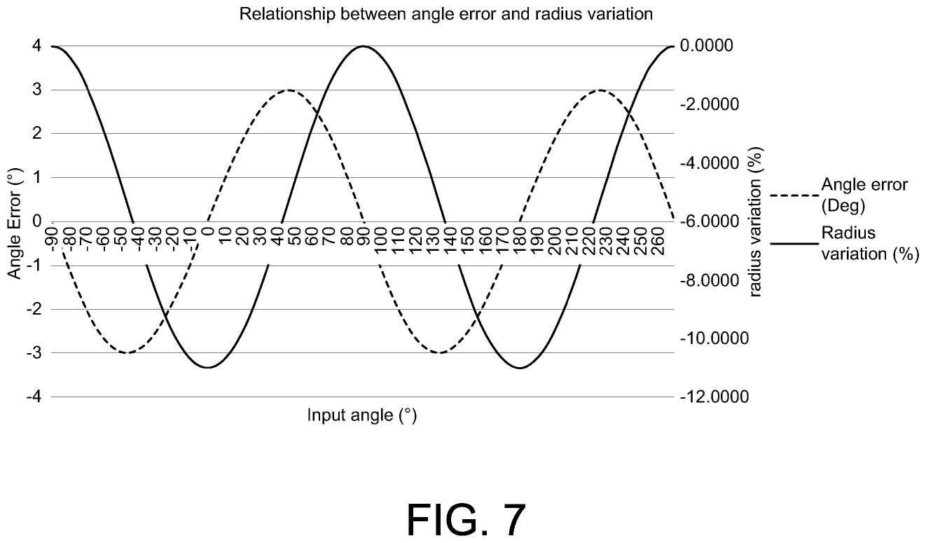

FIG. 7 shows a plot illustrating a relationship between an angle error and radius variation due to a gain in a cosine output signal according to one or more examples. The plot may represent impact of the gain in the cosine output signal and changes in the angle error and the radius variation for the input angle. The cosine output signal may be obtained from the system 100. The angle error is represented by a dark gray curve. The angle error may range from about −3 degrees to about 3 degrees. The radius variation is represented by a light gray curve. The radius variation may range from about −11 percent to about 0 percent.

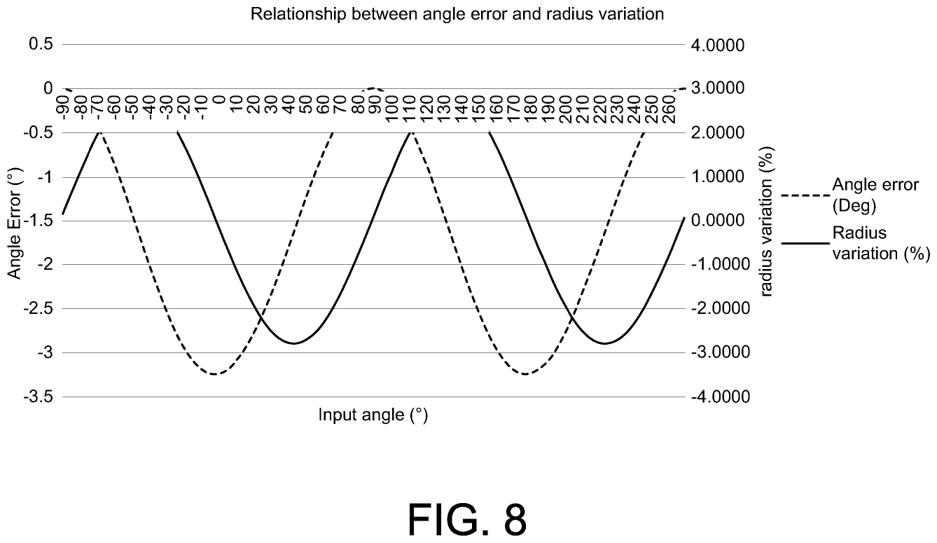

FIG. 8 shows a plot illustrating a relationship between an angle error and radius variation due to a propagation delay in a sine output signal according to one or more examples. The plot may represent impact of the propagation delay on the sine output signal and changes in the angle error and the radius variation for the input angle. The sine output signal may be obtained from the system 100. The angle error is represented by a dark gray curve. The angle error may range from about −3.25 degrees to about 0 degrees. The radius variation is represented by a light gray curve. The radius variation may range from about −2.8 percent to about 2.9 percent.

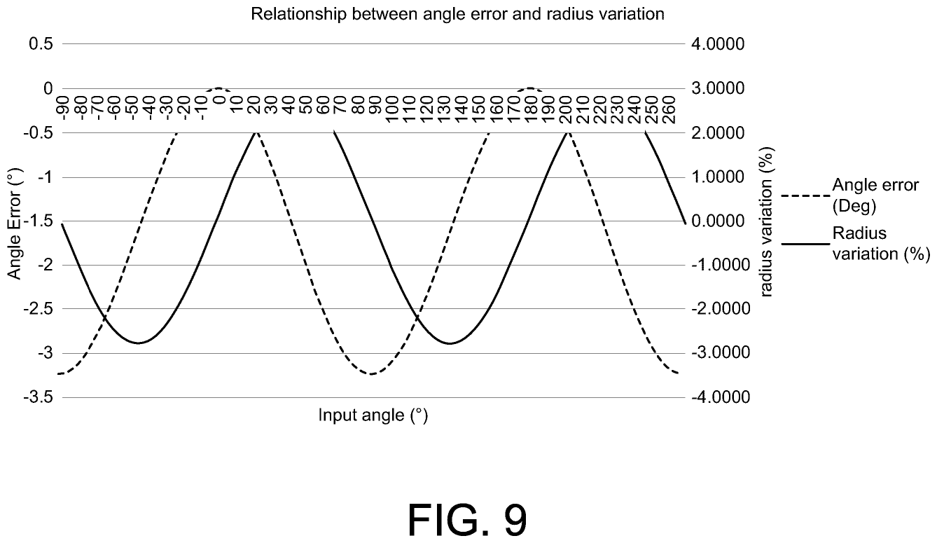

FIG. 9 shows a plot illustrating a relationship between an angle error and radius variation due to a propagation delay in a cosine output signal according to one or more examples. The plot may represent impact of the propagation delay on the cosine output signal and changes in the angle error and the radius variation for the input angle. The cosine output signal may be obtained from the system 100. The angle error is represented by a dark gray curve. The angle error may range from about −3.25 degrees to about 0 degrees. The radius variation is represented by a light gray curve. The radius variation may range from about −2.8 percent to about 2.9 percent.

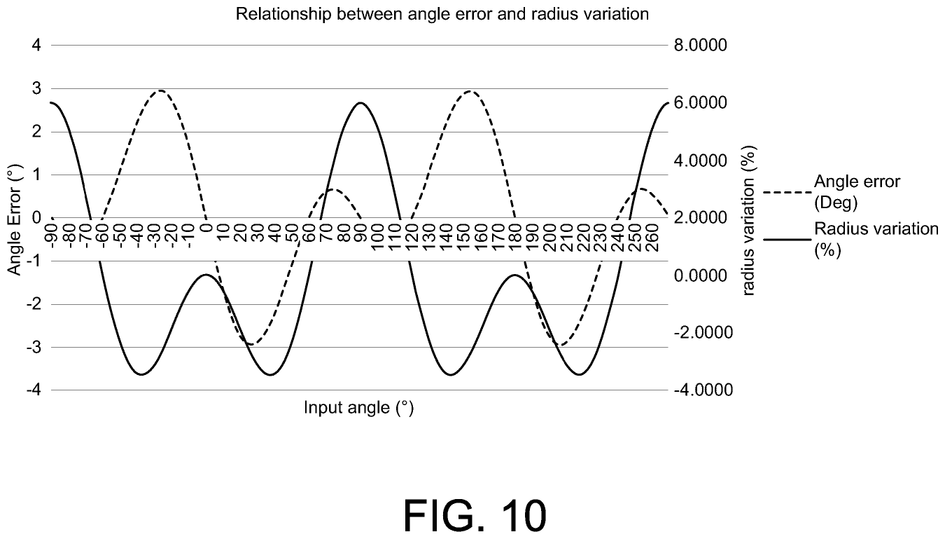

FIG. 10 shows a plot illustrating a relationship between an angle error and radius variation due to a third harmonic in a sine output signal according to one or more examples. The plot may represent impact of the third harmonic on the sine output signal and changes in the angle error and the radius variation for the input angle. The sine output signal may be obtained from the system 100. The angle error is represented by a dark gray curve. The angle error may range from about −3 degrees to about 3 degrees. The radius variation is represented by a light gray curve. The radius variation may range from about −3.5 percent to about 6 percent.

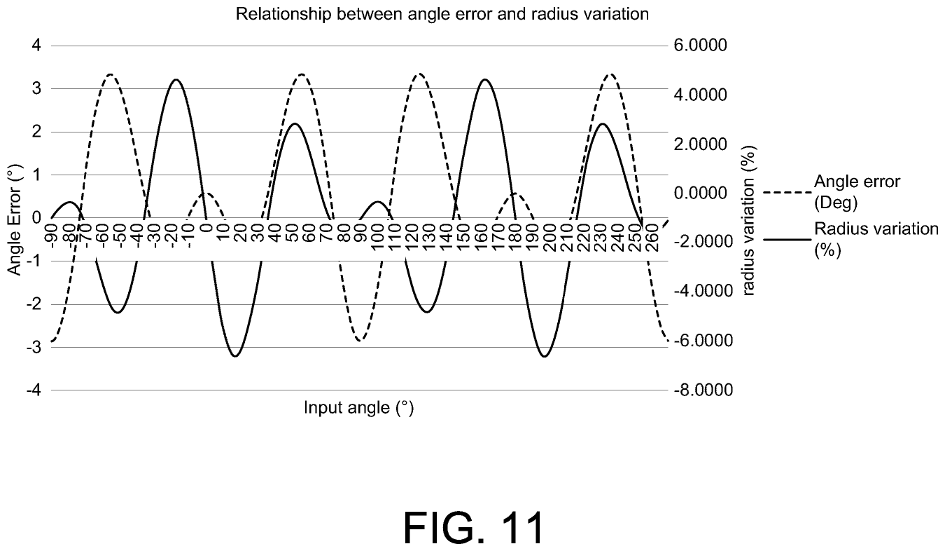

FIG. 11 shows a plot illustrating a relationship between an angle error and radius variation due to a fifth harmonic in a sine output signal according to one or more examples. The plot may represent impact of the fifth harmonic on the sine output signal and changes in the angle error and the radius variation for the input angle. The sine output signal may be obtained from the system 100. The angle error is represented by a dark gray curve. The angle error may range from about −3.25 degrees to about 3.25 degrees. The radius variation is represented by a light gray curve. The radius variation may range from about −6 percent to about 4.8 percent.

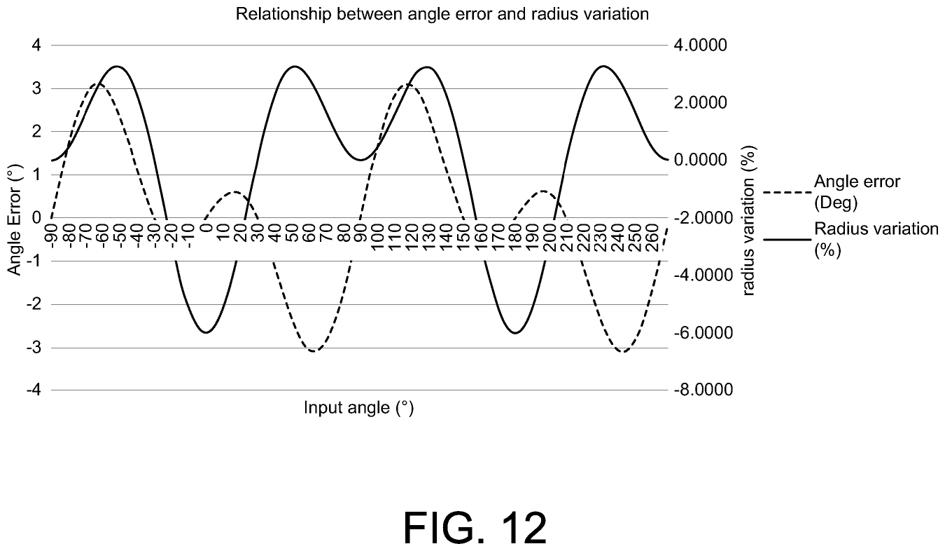

FIG. 12 shows a plot illustrating a relationship between an angle error and radius variation due to a third harmonic in a cosine output signal according to one or more examples. The plot may represent impact of the third harmonic on the cosine output signal and changes in the angle error and the radius variation for the input angle. The cosine output signal may be obtained from the system 100. The angle error is represented by a dark gray curve. The angle error may range from about −3.1 degrees to about 3.1 degrees. The radius variation is represented by a light gray curve. The radius variation may range from about −6 percent to about 3.25 percent.

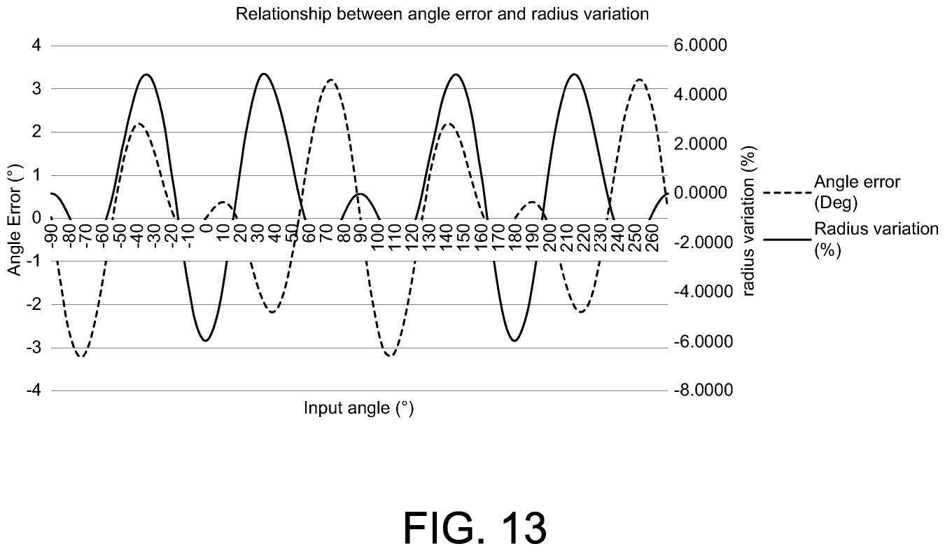

FIG. 13 shows a plot illustrating a relationship between an angle error and radius variation due to a fifth harmonic in a cosine output signal according to one or more examples. The plot may represent impact of the fifth harmonic on the cosine output signal and changes in the angle error and the radius variation for the input angle. The cosine output signal may be obtained from the system 100. The angle error is represented by a dark gray curve. The angle error may range from about −3.25 degrees to about 3.25 degrees. The radius variation is represented by a light gray curve. The radius variation may range from about −6 percent to about 4.8 percent.

Various examples have been disclosed herein, in connection with the above description and the drawings. It will be understood that it would be unduly repetitious to literally describe and illustrate each combination and subcombination of these examples. Accordingly, all examples can be combined in any way or combination, and the present specification, including the drawings, shall be construed to constitute a complete written description of all combinations and subcombinations of these examples herein, and of the manner and process of making and using them, and shall support claims to any such combination or subcombination.

It will be appreciated by persons skilled in the art that the examples described herein are not limited to what has been particularly shown and described herein above. In addition, unless mention was made above to the contrary, it is to be noted that all of the accompanying drawings are not to scale. A variety of modifications and variations are possible in light of the above teachings.

What is claimed is:

1. A system for monitoring analog-front-end (AFE) circuitry of an inductive position sensor, the system comprising:
a sine signal AFE channel coupled to the inductive position sensor;
a sine AFE channel buffer;
a cosine signal AFE channel coupled to the inductive position sensor;
a cosine AFE channel buffer;
an automatic gain control (AGC) circuit coupled to the sine signal AFE channel and the cosine signal AFE channel to form an AGC loop to control an amplitude of an input analog sine wave and an input analog cosine wave;
a memory to store a plurality of parameters; and
a processor to:
obtain a first voltage difference between a sine AFE output voltage and an estimated sine AFE output voltage;
obtain a second voltage difference between a cosine AFE output voltage and an estimated cosine AFE output voltage;
determine if the first or second voltage difference is greater than a predetermined threshold value; and
signal a fault condition if the first or second voltage difference is greater than the predetermined threshold value.

2. The system of claim 1, wherein the AGC circuit is to maintain a sum of squares of the input analog sine wave and the input analog cosine wave to a constant value.

3. The system of claim 1, wherein the plurality of parameters comprises a default radius, an initial error threshold, a conservative error threshold, and a maximum allowable error count within a fault tolerable time interval (FTTI).

4. The system of claim 1, wherein the first or second voltage difference is attributable to one or more error sources at the AFE circuitry of the inductive position sensor.

5. The system of claim 1, wherein the inductive position sensor is selected from a rotary position sensor and a linear position sensor.

6. The system of claim 1, comprising a temperature sensor to measure an internal temperature.

7. The system of claim 6, wherein the processor is to:
read a default radius from the memory;
acquire the sine AFE output voltage from the sine AFE channel buffer and the cosine AFE output voltage from the cosine AFE channel buffer;
estimate a current radius based on the sine AFE output voltage and the cosine AFE output voltage;
rectify the default radius based on the internal temperature and a temperature slope;
calculate the estimated sine AFE output voltage based on a rectified default radius and the cosine AFE output voltage; and
calculate the estimated cosine AFE output voltage based on the rectified default radius and the sine AFE output voltage.

8. The system of claim 1, wherein the processor is to adjust error thresholds based on temperature variations detected by a temperature sensor.

9. The system of claim 1, comprising a diagnostic module to perform periodic self-tests of the AFE circuitry.

10. The system of claim 1, wherein the system is to log error events and store fault data in the memory for diagnostic analysis.

11. A method for monitoring analog-front-end (AFE) circuitry of an inductive position sensor, the method comprising:
establishing an automatic gain control (AGC) loop to control an amplitude of an input analog sine wave and an input analog cosine wave using an AGC circuit coupled to a sine signal AFE channel and a cosine signal AFE channel;
obtaining a first voltage difference between a sine AFE output voltage and an estimated sine AFE output voltage;
obtaining a second voltage difference between a cosine AFE output voltage and an estimated cosine AFE output voltage;
determining if the first or second voltage difference is greater than a predetermined threshold value; and
signaling a fault condition if the first or second voltage difference is greater than the predetermined threshold value.

12. The method of claim 11, wherein the AGC circuit is to maintain a sum of squares of the input analog sine wave and the input analog cosine wave to a constant value.

13. The method of claim 11, comprising storing, at a memory, a plurality of parameters.

14. The method of claim 13, wherein the plurality of parameters comprises a default radius, an initial error threshold, a conservative error threshold, and a maximum allowable error count within a fault tolerable time interval (FTTI).

15. The method of claim 11, wherein the first or second voltage difference is attributable to one or more error sources at the AFE circuitry of the inductive position sensor.

16. The method of claim 11, wherein the inductive position sensor is selected from a rotary position sensor and a linear position sensor.

17. The method of claim 11, comprising measuring, at a temperature sensor, an internal temperature.

18. The method of claim 17, comprising:
reading a default radius from a memory;
acquiring the sine AFE output voltage from a sine AFE channel buffer and the cosine AFE output voltage from a cosine AFE channel buffer;
estimating a current radius based on the sine AFE output voltage and the cosine AFE output voltage;
rectifying the default radius based on the internal temperature and a temperature slope;
calculating the estimated sine AFE output voltage based on a rectified default radius and the cosine AFE output voltage; and
calculating the estimated cosine AFE output voltage based on the rectified default radius and the sine AFE output voltage.

19. The method of claim 11, comprising transmitting fault condition data to an external monitoring system.

20. The method of claim 11, comprising adjusting input gain control parameters based on historical performance data stored in the memory.
